(19) United States
(12) Patent Application Publication
(10) Pub. No.: US 2023/0347527 A1
(43) Pub. Date: Nov. 2, 2023

(54) COMMUNICATION SYSTEM, CONTROL METHOD, AND STORAGE MEDIUM

(71) Applicant: TOYOTA JIDOSHA KABUSHIKI KAISHA, Toyota-shi (JP)

(72) Inventor: Takuma SUGINO, Miyoshi-shi (JP)

(73) Assignee: TOYOTA JIDOSHA KABUSHIKI KAISHA, Toyota-shi (JP)

(21) Appl. No.: 18/173,457

(22) Filed: Feb. 23, 2023

(30) Foreign Application Priority Data
May 2, 2022 (JP) 2022-076208

(51) Int. Cl. B25J 11/00

(52) U.S. Cl. CPC B25J 11/0015

(57) ABSTRACT

A communication system according to an aspect of the present disclosure is a communication system in which an operator who remotely operates a robot using an operation terminal communicates with a communication partner who is present around the robot via the robot, and includes a control unit that causes the robot to perform a bridging motion that is set in advance when a communication failure occurs between the operation terminal and the robot.

### CROSS-REFERENCE TO RELATED APPLICATION

This application claims priority to Japanese Patent Application No. 2022-076208 filed on May 2, 2022, incorporated herein by reference in its entirety.

### BACKGROUND

### 1. Technical Field

The present disclosure relates to a communication system, a control method, and a storage medium.

### 2. Description of Related Art

With recent development of the communication technology, it has become possible for people who are separated from each other to communicate with each other in real time. On the basis of this, various communication systems have been under development.

For example, Japanese Unexamined Patent Application Publication No. 2021-132284 (JP 2021-132284 A) discloses a communication system in which an operator who remotely operates a robot using an operation terminal can communicate with a communication partner present around the robot via the robot.

### SUMMARY

The applicant has found the following issue. There is a possibility that, in a general communication system, when a communication failure occurs between the robot and the operation terminal while the operator and the communication partner are communicating via the robot, the communication partner who communicates with the operator via the robot may feel annoyed.

The present disclosure has been made in view of the issue above, and realizes a communication system, a control method, and a storage medium that can reduce annoyance felt by the communication partner who communicates with the operator via the robot even when a communication failure occurs between the robot and the operation terminal.

A communication system according to an aspect of the present disclosure is a communication system in which an operator who remotely operates a robot using an operation terminal communicates with a communication partner who is present around the robot via the robot, and includes a control unit that causes the robot to perform a bridging motion that is set in advance when a communication failure occurs between the operation terminal and the robot.

It is preferable that the above-described communication system include a first determination unit that determines a communication state between the operation terminal and the robot, and when the communication state is a first communication failure state that is set in advance, the control unit switch from a remote operation mode in which the robot is remotely operated via the operation terminal to an autonomous control mode in which the robot performs the bridging motion.

In the above-described communication system, it is preferable that the first determination unit determine a communication level based on a communication speed between the robot and the operation terminal, and the control unit select the bridging motion corresponding to the communication level from among a plurality of the bridging motions for which required times that are set in advance are different from each other, and cause the robot to perform the selected bridging motion.

In the above-described communication system, it is preferable that the control unit select the bridging motion corresponding to a situation in which the robot is actually used from among a plurality of the bridging motions set in advance corresponding to situations in which the robot is used, and cause the robot to perform the selected bridging motion.

In the above-described communication system, it is preferable that the bridging motion be a motion that imitates a motion of a person that causes a conversation to be interrupted during the conversation.

The above-described communication system preferably further includes: a second determination unit that determines whether a person who speaks just before the communication state becomes a second communication failure state that is set in advance is the operator or the communication partner; and a storage unit that stores, when the person who speaks just before the communication state becomes the second communication failure state is the communication partner, sound uttered by the communication partner to the operator via the robot from when the communication state becomes the second communication failure state until the second communication failure state is resolved.

A control method according to an aspect of the present disclosure is a control method of a communication system in which an operator who remotely operates a robot using an operation terminal communicates with a communication partner who is present around the robot via the robot, and includes causing the robot to perform a bridging motion that is set in advance when a communication failure occurs between the robot and the operation terminal.

A storage medium according to an aspect of the present disclosure stores a control program that is a control program of a communication system in which an operator who remotely operates a robot using an operation terminal communicates with a communication partner who is present around the robot via the robot, and the control program causes a computer to execute a process of causing the robot to perform a bridging motion set in advance when a communication failure occurs between the robot and the operation terminal.

According to the present disclosure, the present disclosure realizes a communication system, a control method, and a storage medium that can reduce annoyance felt by the communication partner who communicates with the operator via the robot even when a communication failure occurs between the robot and the operation terminal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for explaining a communication system according to a first embodiment;

FIG. 2 is a diagram showing an example of the external configuration of a robot according to the first embodiment;

FIG. 3 is a block diagram for explaining the system configuration of the robot according to the first embodiment;

FIG. 4 is a block diagram for explaining the system configuration of an operation terminal according to the first embodiment;

FIG. 5 is a block diagram for explaining the system configuration of a management server according to the first embodiment;

FIG. 6 shows a flowchart for explaining an operation of the robot in an autonomous control mode in the communication system according to the first embodiment;

FIG. 7 shows the flowchart for explaining the operation of the robot in the autonomous control mode in the communication system according to the first embodiment;

FIG. 8 is a block diagram for explaining the system configuration of the robot according to a second embodiment; and

FIG. 9 is a diagram showing an example of the hardware configuration included in the communication system.

### DETAILED DESCRIPTION OF EMBODIMENTS

Hereinafter, specific embodiments to which the present disclosure is applied will be described in detail with reference to the drawings. However, the present disclosure is not limited to the following embodiments. Further, in order to clarify the description, the following description and drawings have been simplified as appropriate.

### First Embodiment

### Communication System

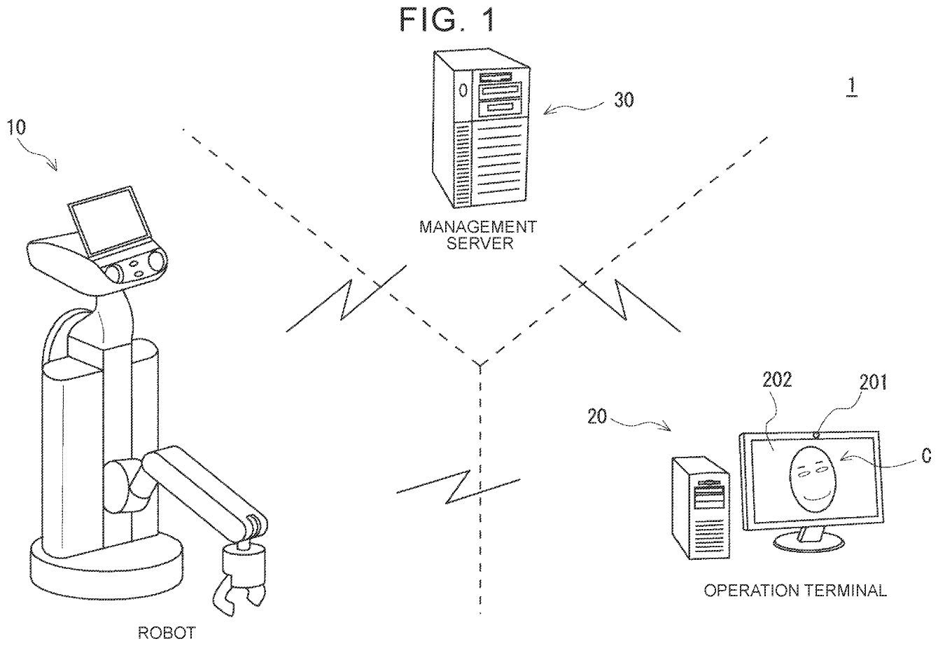

FIG. 1 is a diagram for explaining a communication system according to the present embodiment. As shown in FIG. 1, a communication system 1 according to the present embodiment includes a robot 10, an operation terminal 20, and a management server 30.

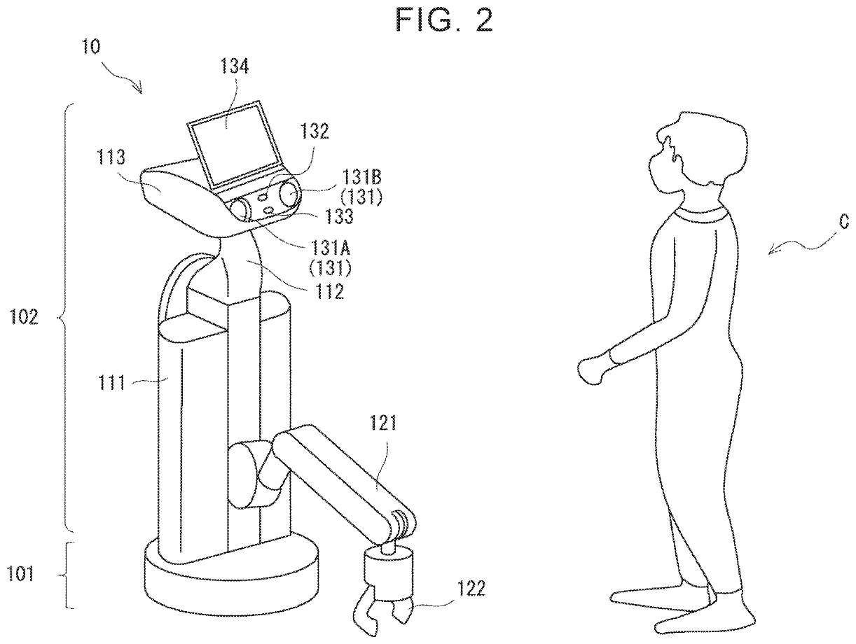

The communication system 1 according to the present embodiment is a communication system in which the robot 10 that is remotely operated by the operation terminal 20 performs communication, such as conversation, with a communication partner C (see FIG. 2) present around the robot 10.

The robot 10 can communicate with the communication partner C as, for example, a home robot or a guide robot. The robot 10 is equipped with a display panel, a microphone and a loudspeaker for performing communication. A detailed configuration of the robot 10 will be described later.

The robot 10 and the operation terminal 20 are disposed at positions separated from each other, and the operator can remotely operate the robot 10 using the operation terminal 20. As will be described later, the robot 10 and the operation terminal 20 are configured to be able to communicate with each other regarding imaging data, audio data, and the like.

Further, the robot 10 and the management server 30, and the operation terminal 20 and the management server 30, are also configured to be able to communicate with each other. Note that the management server 30 may be disposed at a position apart from the robot 10 and the operation terminal 20, may be disposed near the operation terminal 20, or may be disposed near the robot 10. The configuration and operation of the communication system 1 according to the present embodiment will be described in detail below.

### External Configuration of Robot

First, the external configuration of the robot 10 will be described. FIG. 2 is a diagram showing an example of the external configuration of the robot according to the present embodiment. As shown in FIG. 2, the robot 10 includes a mobile unit 101 and a main body portion 102. The mobile unit 101 is a unit for moving the robot 10.

For example, wheels (not shown) are provided on the lower surface of the mobile unit 101, and the wheels are driven via a motor (not shown) based on an operation signal received from the operation terminal 20, whereby the robot 10 can be moved or rotated freely on a flat plane.

The main body portion 102 is mounted on the upper portion of the mobile unit 101 and includes a trunk portion 111, a connection portion 112 and a head portion 113. The trunk portion 111 is mounted on the upper portion of the mobile unit 101, and the connection portion 112 connects the trunk portion 111 and the head portion 113.

The trunk portion 111 includes an arm 121 supported in the front of the trunk portion 111 and a hand 122 provided at the tip end portion of the arm 121. The arm 121 and the hand 122 are driven by a motor (not shown) based on an operation signal received from the operation terminal 20, and hold various objects in controlled postures and perform gestures to express emotions, for example.

The head portion 113 includes a stereo camera 131, a microphone 132, a loudspeaker 133, and a display panel 134, and has a configuration for performing communication with the communication partner C.

The stereo camera 131 has a configuration in which two camera units 131A, 131B having the same angle of view are disposed apart from each other, and images captured by the respective camera units 131A, 131B are generated as imaging data. The robot 10 transmits the imaging data to the operation terminal 20. Here, the imaging data may be a still image or a moving image.

The microphone 132 acquires the voice of the communication partner C and converts the voice into the audio data. The robot 10 transmits the audio data to the operation terminal 20. The loudspeaker 133 may select the audio data that is stored in the robot 10 in advance and output the sound of the selected audio data, or may output the sound generated in accordance with instructions received from the operation terminal 20. Further, the sound of the audio data received from the operation terminal 20 can be output.

The display panel 134 is, for example, a liquid crystal panel, and displays a face image (actual captured image or processed image generated in advance) to the communication partner C. When the face of the actual image or the processed image is displayed on the display panel 134, it is possible to give the communication partner C the impression that the display panel 134 is a pseudo face portion.

In addition, the display panel 134 can display information such as characters and pictures (for example, icons) to the communication partner C. Information such as the above-described face image, characters, and pictures displayed on the display panel 134 may be stored in or generated by the robot 10, or may be received from the operation terminal 20 as display data.

Here, the direction in which the head portion 113 faces can be changed as the mobile unit 101 changes the direction of the robot 10. With the above, the stereo camera 131 can capture an image of an object in an arbitrary direction, and the microphone 132 can acquire sound from an arbitrary direction. Further, each of the loudspeaker 133 and the display panel 134 can emit the sound in an arbitrary direction and present display contents in an arbitrary direction.

### System Configuration of Robot

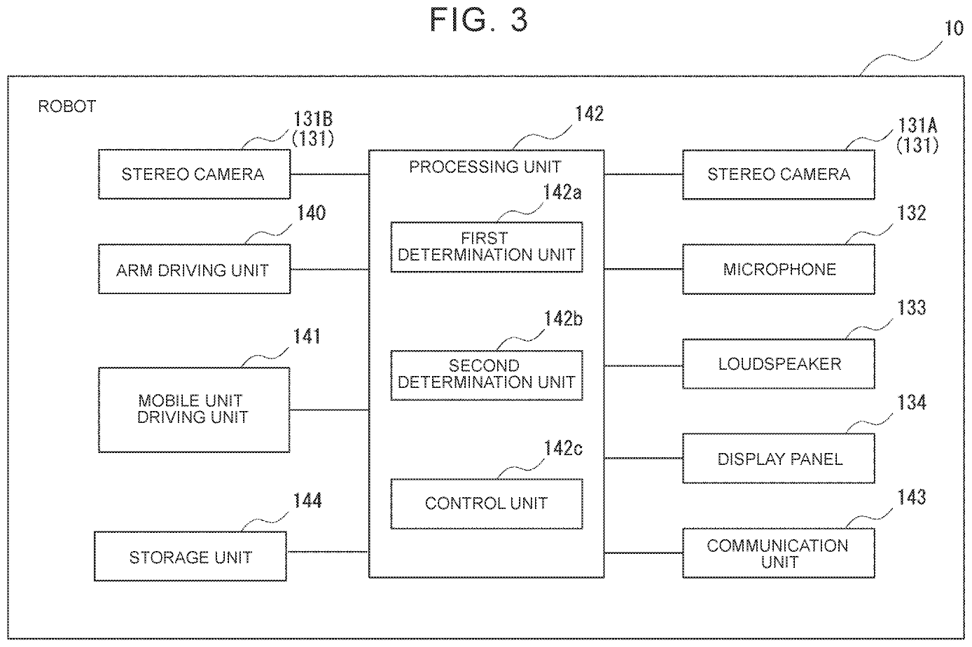

Next, the system configuration of the robot 10 will be described. FIG. 3 is a block diagram for explaining the system configuration of the robot according to the present embodiment. As shown in FIG. 3, the robot 10 includes an arm driving unit 140, a mobile unit driving unit 141, a processing unit 142, a communication unit 143, and a storage unit 144, in addition to the stereo camera 131, the microphone 132, the loudspeaker 133, the display panel 134 as the system configuration.

The arm driving unit 140 is means for driving the arm 121 and the hand 122, and can be configured using, for example, a motor. The arm driving unit 140 drives the arm 121 and the hand 122 based on control signals input from the processing unit 142.

The mobile unit driving unit 141 is means for driving the mobile unit 101, and can be configured using, for example, a motor. The mobile unit driving unit 141 drives the mobile unit 101 based on the control signal input from the processing unit 142.

The processing unit 142 controls processing of each unit of the robot 10 based on a remote operation mode that is based on remote operation of the operation terminal 20 or an autonomous control mode in which a bridging motion is performed until a communication failure between the robot 10 and the operation terminal 20 is resolved, and is connected to other components via a bus.

The processing unit 142 includes a first determination unit 142a, a second determination unit 142b, and a control unit 142c. The first determination unit 142a determines the communication state between the robot 10 and the operation terminal 20. The first determination unit 142a determines a communication level as a communication state in accordance with a communication speed between the robot 10 and the operation terminal 20, for example.

Here, for example, the communication speed between the robot 10 and the operation terminal 20 can be measured by measuring a ping value (that is, a response speed) when a ping is transmitted from the robot 10 to the operation terminal 20.

For example, when the response speed is 0 ms to 40 ms, the first determination unit 142a determines that the communication state is at a communication level 5 at which the communication state is the best, and when the response speed is 41 ms to 60 ms, the first determination unit 142a determines that the communication state is at a communication level 4 at which the communication state is good. When the response speed is 61 ms to 100 ms, the first determination unit 142a determines that the communication state is at a communication level 3 at which the communication state is rather poor.

For example, when the response speed is 101 ms or more, the first determination unit 142a determines that the communication state is at a communication level 2 at which the communication state is poor, and when there is no response, the first determination unit 142a determines that the communication state is at a communication level 1 at which the communication state is the worst. At this time, for example, when the communication level is “3” or less, the communication state corresponds to a first communication failure state, and when the communication level is “2” or less, the communication state corresponds to a second communication failure state. However, a general method can be used as the method for determining the communication state between the robot 10 and the operation terminal 20.

The second determination unit 142b determines whether the person who speaks immediately before the communication state between the robot 10 and the operation terminal 20 becomes the second communication failure state is either the operator or the communication partner C.

When the conversation immediately before the communication state between the robot 10 and the operation terminal 20 becomes the second communication failure state and the voice of the operator operating the operation terminal 20 are stored in the storage unit 144, for example, the second determination unit 142b determines whether the speaker immediately before the communication state becomes the second communication failure state is the operator using voice authentication technology or the like. Then, when the speaker immediately before the communication state becomes the second communication failure state is not the operator, the second determination unit 142b determines that the speaker immediately before the communication state becomes the second communication failure state is the communication partner C.

The control unit 142c controls the stereo camera 131, the microphone 132, the loudspeaker 133, the display panel 134, the arm driving unit 140, the mobile unit driving unit 141, the communication unit 143, and the storage unit 144 based on the determination results by the first determination unit 142a and the second determination unit 142b.

For example, when the first determination unit 142a determines that the communication level is 5 or 4, the control unit 142c controls the robot 10 in a remote operation mode based on a remote operation of the operation terminal 20.

That is, in the remote operation mode, the control unit 142c transmits the imaging data of the communication partner C acquired from the stereo camera 131 and the audio data of the communication partner C acquired from the microphone 132 to the operation terminal 20 via the communication unit 143.

The control unit 142c outputs the sound of the audio data received from the operation terminal 20 via the communication unit 143 from the loudspeaker 133. Further, the control unit 142c causes the display panel 134 to display an image of the imaging data received from the operation terminal 20 via the communication unit 143.

The control unit 142c generates a control signal based on the operation signal received from the operation terminal 20 via the communication unit 143, controls the arm driving unit 140 based on the generated control signal, and drives the arm 121 and the hand 122. With the above, the arm 121 and the hand 122 of the robot 10 can be moved by the remote operation.

The control unit 142c generates a control signal based on the operation signal received from the operation terminal 20 via the communication unit 143, controls the mobile unit driving unit 141 based on the generated control signal, and drives the mobile unit 101. With the above, the robot 10 can be moved to any place based on the remote operation of the operation terminal 20.

For example, when the first determination unit 142a determines that the communication level is 3, the control unit 142c controls the robot 10 by switching the control of the robot 10 to the autonomous control mode, except transmission and reception of the audio data, while maintaining transmission and reception of the audio data between the operator and the communication partner C. In other words, the communication level 3 is the level at which the voice dialogue can be continued although the communication state is not good. Therefore, the entire control of the robot 10 is not switched to the autonomous control mode.

For example, when the first determination unit 142a determines that the communication level is 1 or 2, the control unit 142c switches the entire control of the robot 10 to the autonomous control mode and controls the robot 10 in the autonomous control mode. In other words, the communication level 1 or 2 is the level at which the communication state is poor and the voice dialogue is not possible. Therefore, the entire control of the robot 10 is switched to the autonomous control mode.

In such an autonomous control mode, the control unit 142c selects a bridging motion corresponding to the communication level from a plurality of the bridging motions having different required times set in advance, and causes the robot 10 to perform the selected bridging motion.

The bridging motion is preferably a motion that imitates a motion of a person that causes the conversation to be interrupted during the conversation. For example, as the bridging motion, motion data indicating a motion of coughing that requires one second as the required time, a motion of waiting for two seconds (however, any number of seconds is acceptable), a motion of yawning that requires three seconds as the required time, a motion of placing a hand over an ear and uttering “I have ringing in my ear” that requires three seconds as the required time, a motion of rubbing an eye by a hand and uttering “I've got something in my eye” that requires five seconds as the required time, and a motion of sneezing that requires five seconds as the required time is stored in the storage unit 144.

At this time, the motion data includes display data in which the character's face moves to imitate the motions described above, audio data emitted when the character moves to imitate the motions, and gesture data that the arm 121 or the like makes a gesture in conjunction with the movement of the character to imitate the motions.

In the case of the communication level 3, the control unit 142c acquires (selects) the motion data indicating the motion of coughing from the storage unit 144. In the case of the communication level 2, the control unit 142c acquires, from the storage unit 144, the motion data indicating the motion of yawning or the motion of uttering “I have ringing in my ear” while placing the hand over the ear. In the case of the communication level 1, the motion data indicating the motion of uttering “I've got something in my eye” while rubbing the eye or the motion of sneezing is acquired from the storage unit 144.

Then, the control unit 142c causes the loudspeaker 133 to output the sound of the audio data included in the acquired motion data, and causes the display panel 134 to display the image of the display data included in the motion data. Also, the control unit 142c causes the arm 121 and the hand 122 to perform the gesture of the gesture data included in the selected motion data.

With the above, in the case of the communication level 3, the sound of coughing of the audio data is output from the loudspeaker 133, and the display panel 134 displays the image of the display data of an expression on the character's face when the character coughs. In the case of the communication level 2, the sound of yawning of the audio data is output from the loudspeaker 133, and the display panel 134 displays the image of the display data of an expression on the character's face when the character yawns.

Alternatively, the sound indicating “I have ringing in my ear” of the audio data is output from the loudspeaker 133, and the display panel 134 displays the image of the display data of an expression on the character's face when the character has ringing. At the same time, the arm 121 and the hand 122 perform the gesture of the gesture data so as to place the hand over the ear of the character's face displayed on the display panel 134.

In the case of the communication level 1, the sound indicating that “I've got something in my eye” of the audio data is output from the loudspeaker 133, and the display panel 134 displays the image of the display data of an expression on the character's face when the character gets something in the eye. At the same time, the arm 121 and the hand 122 perform the gesture of the gesture data so as to rub the eye of the character's face displayed on the display panel 134.

Alternatively, the sound of sneezing of the audio data is output from the loudspeaker 133, and the display panel 134 displays the image of the display data of an expression on the character's face when the character sneezes. As described above, the robot 10 can be made to behave as if the character displayed on the display panel 134 is moving in imitation of the above-described motions.

It should be noted that the “bridging motion” is a phenomenon that includes, in addition to gestures, sounds accompanying the gestures, as described above. However, the bridging motion is not limited to the above-described motions, as long as the bridging motion is a motion that can bridge the duration during which the communication failure between the robot 10 and the operation terminal 20 continues.

When the second determination unit 142b determines that the speaker immediately before the communication state becomes the second communication failure state is the communication partner C, the control unit 142c stores the audio data acquired from the microphone 132 in the storage unit 144 from when the communication state becomes the second communication failure state until the second communication failure state is resolved (for example, until the communication level changes from “2” or lower to “3” or higher).

The communication unit 143 is configured to be able to communicate with each of the operation terminal 20 and the management server 30 by wire or wirelessly. The storage unit 144 stores the motion data indicating the bridging motions to be performed by the robot 10 and the audio data acquired from the microphone 132. At this time, the storage unit 144 preferably stores data received from the operation terminal 20 (for example, the audio data and the imaging data) and the display data of information such as characters and pictures necessary for communication.

### Configuration of Operation Terminal

Next, the operation terminal 20 will be described. As shown in FIG. 1, the operation terminal 20 is a terminal for the operator to remotely operate the robot 10, and is a computer that can be configured using, for example, a personal computer or a tablet terminal. The operation terminal 20 includes a camera 201 and a display unit 202 on the appearance of the operation terminal 20.

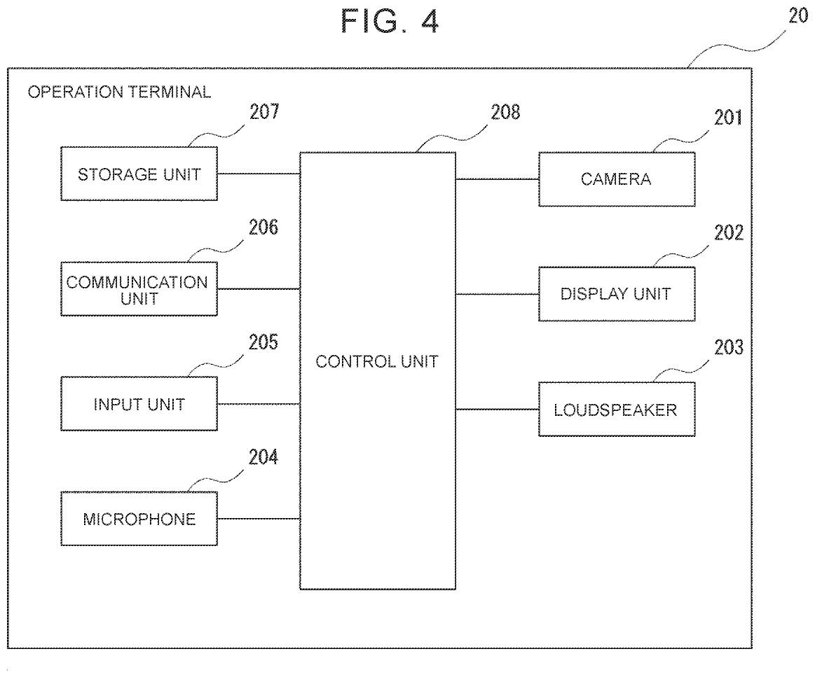

FIG. 4 is a block diagram for explaining the system configuration of the operation terminal according to the present embodiment. As shown in FIG. 4, the operation terminal 20 includes the camera 201, the display unit 202, a loudspeaker 203, a microphone 204, an input unit 205, a communication unit 206, a storage unit 207 and a control unit 208.

The control unit 208 has a function of controlling the operation terminal 20, and the camera 201, the display unit 202, the loudspeaker 203, the microphone 204, the input unit 205, and the communication unit 206 are connected to the control unit 208.

The camera 201 generates an image of the operator of the operation terminal 20 in front of the display unit 202 of the operation terminal 20 as the imaging data. The display unit 202 displays an image of the imaging data transmitted from the robot 10 and the like. The loudspeaker 203 outputs the sound of the audio data transmitted from the robot 10.

With the above, the operator of the operation terminal 20 can confirm the face, voice, etc. of the communication partner C. The microphone 204 acquires the voice of the operator and converts the voice into the audio data.

The input unit 205 is means for the operator to input information to the operation terminal 20. Various types of information for remote operation of the robot 10 are input when the operator operates the input unit 205. The control unit 208 transmits the input information input from the input unit 205 to the robot 10 from the communication unit 206 as an operation signal.

For example, the input unit 205 can be configured using a touch panel or a keyboard. For example, when the input unit 205 is configured using a touch panel, the operator can remotely operate the robot 10 by pressing an icon or the like displayed on the display unit 202. Further, when the input unit 205 is configured using a keyboard, for example, the operator can remotely operate the robot 10 by inputting predetermined information via the keyboard.

The remote operations performed through such input from the input unit 205 include, for example, movement of the entire robot 10, driving of the arm 121 and the hand 122, output of the sound from the loudspeaker 133, and determination and change of the display contents on the display panel 134. However, the remote operations are not limited to the above.

The communication unit 206 is configured to communicate with each of the robot 10 and the management server 30 by wire or wirelessly. Under the control of the control unit 208, the storage unit 207 can store the imaging data acquired from the camera 201, the audio data acquired from the microphone 204, the input information acquired from the input unit 205, and the like. Further, the storage unit 207 may store the imaging data, the audio data, and the like acquired from the robot 10.

The control unit 208 controls processing of each unit of the operation terminal 20, and is connected to other components via a bus. The control unit 208 can transmit the imaging data acquired from the camera 201 and the audio data acquired from the microphone 204 to the robot 10 via the communication unit 206. Further, the control unit 208 can transmit input information related to remote control of the robot 10 input from the input unit 205 to the robot 10 via the communication unit 206 as an operation signal.

The control unit 208 outputs the sound of the audio data received from the robot 10 via the communication unit 206 from the loudspeaker 203, and displays the image of the imaging data received from the robot 10 via the communication unit 206 on the display unit 202. Further, the control unit 208 can cause the storage unit 207 to store various types of acquired data, and can also read out or delete any stored data.

### Configuration of Management Server

Next, the management server 30 will be described. As shown in FIG. 1, the management server 30 is a server for managing the robot 10. The management server 30 is configured to be able to communicate with the robot 10 and the operation terminal 20 respectively.

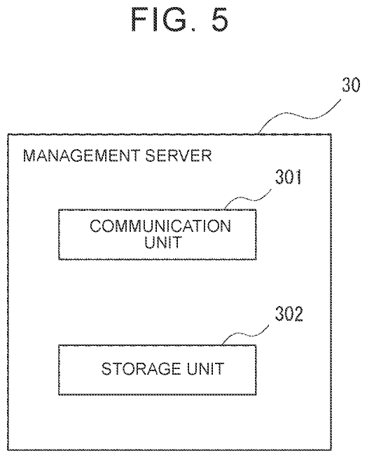

FIG. 5 is a block diagram for explaining the system configuration of the management server according to the present embodiment. As shown in FIG. 5, the management server 30 includes a communication unit 301 and a storage unit 302. The communication unit 301 is configured to be able to communicate with the communication unit 143 of the robot 10 and the communication unit 206 of the operation terminal 20 by wire or wirelessly. The storage unit 302 stores various types of information necessary for controlling the communication unit 301.

Note that the operation terminal 20 and the management server 30 may be configured to communicate with each of a plurality of the robots 10 and manage the robots 10. Further, the management server 30 may configure the same computer system as the operation terminal 20.

### Description of Basic Operation in Remote Operation Mode of Communication System

Next, the basic operation in the remote operation mode of the communication system 1 according to the present embodiment will be described. Here, the operation of the communication system 1 according to the present embodiment in the remote operation mode is substantially the same as the operation of the general communication system 1 in the remote operation mode, and therefore will be briefly described. In the following description, it is assumed that a person is already present in front of the robot 10 and that the person has been identified as the communication partner C who communicates with the operator.

At this time, a method of identifying the communication partner C can be executed in a manner such that, for example, the operator selects the communication partner C from a plurality of face portions of the images displayed on the display unit 202 of the operation terminal 20 via the input unit 205.

When the remote operation mode of the communication system 1 is started, the image acquired by the camera 201 that captures the image of the operator is always generated as the imaging data, and the microphone 204 acquires the voice of the operator and converts the voice into the audio data, on the side of the operation terminal 20. Then, the control unit 208 of the operation terminal 20 transmits the imaging data and the audio data to the robot 10 via the communication unit 206.

At this time, when the operator inputs information for remotely operating the robot 10 via the input unit 205 of the operation terminal 20, the control unit 208 transmits the input information input from the input unit 205 to the robot 10 via the communication unit 206 as an operation signal.

The control unit 142c of the robot 10 causes the display panel 134 to display the image of the imaging data received via the communication unit 143 and outputs the sound of the audio data from the loudspeaker 133. At this time, when the control unit 142c receives the operation signal via the communication unit 143, the control unit 142c generates the control signal based on the operation signal, and drives the arm 121 and the hand 122 by controlling the arm driving unit 140 and also drives the mobile unit 101 by controlling the mobile unit driving unit 141.

On the other hand, on the robot 10 side, the stereo camera 131 constantly captures the image of the communication partner C and generates captured images as the imaging data, and the microphone 132 acquires the voice of the communication partner C and converts the voice into the audio data. Then, the control unit 142c of the robot 10 transmits the imaging data and the audio data to the operation terminal 20 via the communication unit 143.

The control unit 208 of the operation terminal 20 causes the display unit 202 to display the image of the imaging data received via the communication unit 206 and outputs the sound of the audio data from the loudspeaker 203. With the above, in the communication system 1, the operator can realize a conversation with the communication partner C via the display unit 202 while remotely operating the robot 10, and the communication partner C can realize a conversation with the operator via the display panel 134 of the robot 10.

At this time, the storage unit 144 of the robot 10 may store the audio data acquired from the microphone 132 and the audio data received from the operation terminal 20.

### Description of Operation of Robot in Autonomous Control Mode

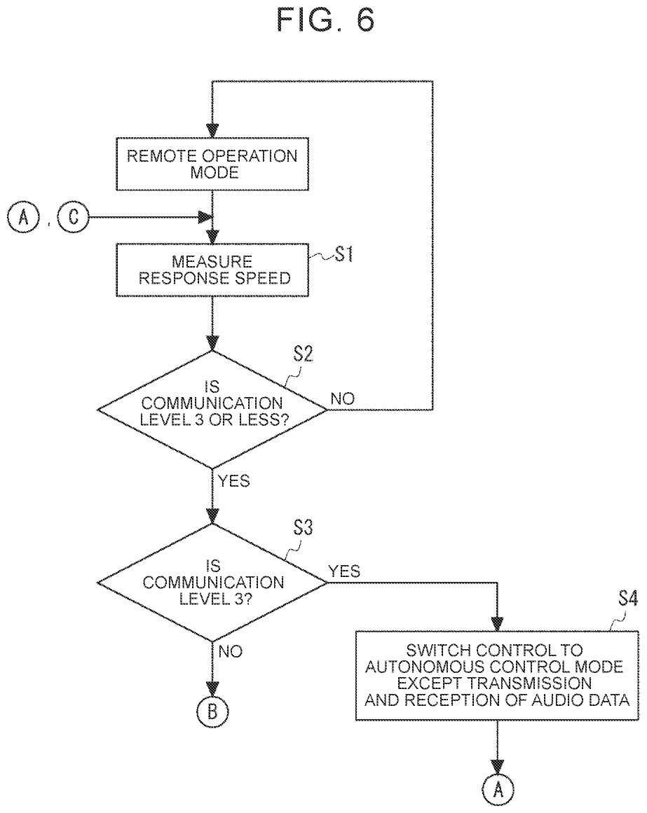

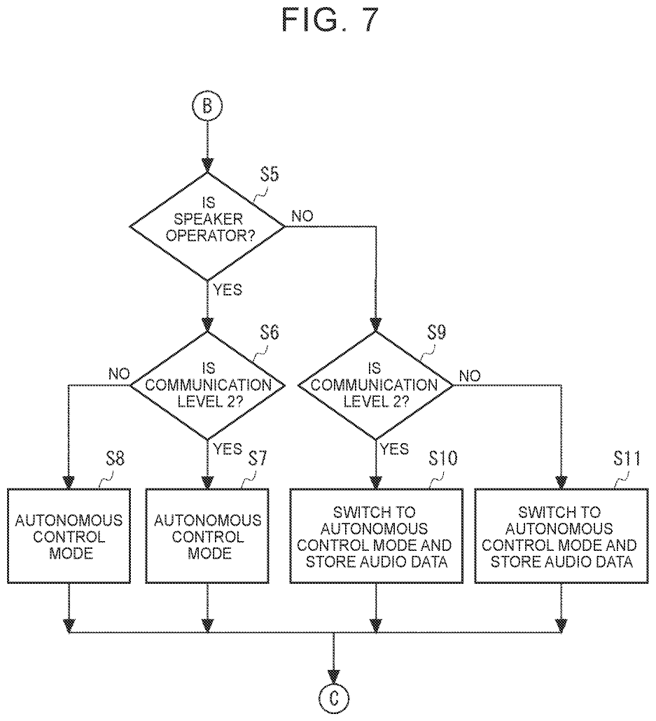

Next, the operation of the robot 10 in the autonomous control mode in the communication system 1 according to the present embodiment will be described. FIGS. 6, 7 show a flowchart for explaining the operation of the robot in the autonomous control mode in the communication system according to the present embodiment.

First, the first determination unit 142a of the robot 10 measures the response speed between the robot 10 and the operation terminal 20 in the remote operation mode described above, and determines the communication level based on the measured response speed (S1). Then, the control unit 142c determines whether the communication level is “3” or less (S2). When the communication level is higher than “3” (NO in S2), the control unit 142c continues the remote operation mode.

On the other hand, when the communication level is “3” or less, the control unit 142c determines whether the communication level is “3” (S3). When the communication level is “3” (YES in S3), the control unit 142c controls the robot 10 by switching the control of the robot 10, except transmission and reception of the audio data, to the autonomous control mode in which the robot 10 performs the bridging motion in the case of the communication level 3, while maintaining transmission and reception of the audio data between the operator and the communication partner C (S4).

Specifically, the control unit 142c outputs the sound of the audio data received from the operation terminal 20 from the loudspeaker 133 and transmits the audio data of the communication partner C acquired by the microphone 132 to the operation terminal 20. The control unit 208 of the operation terminal 20 causes the loudspeaker 203 to output the sound of the audio data received from the robot 10.

At the same time, the control unit 142c acquires the motion data indicating the motion of coughing from the storage unit 144, causes the loudspeaker 133 to output the sound of coughing of the audio data, and causes the display panel 134 to display the image of the display data of the expression on the character's face when the character coughs. When the robot 10 completes performing a series of bridging motions in this manner, the process returns to step S1.

On the other hand, when the communication level is not “3” (NO in S3), the second determination unit 142b determines whether the person who speaks just before the communication level becomes “2” or less is the operator (S5). Then, when the speaker is the operator (YES in S5), the control unit 142c determines whether the communication level is “2” (S6).

Next, when the communication level is “2” (YES in S6), the control unit 142c switches the mode to the autonomous control mode in which the robot 10 performs the bridging motion in the case of the communication level 2, and controls the robot 10 (S7).

In detail, the control unit 142c acquires the motion data indicating the motion of yawning from the storage unit 144, causes the loudspeaker 133 to output the sound of yawning of the audio data, and causes the display panel 134 to display the image of the display data of the expression on the character's face when the character yawns.

Alternatively, the control unit 142c acquires the motion data indicating the motion of uttering “I have ringing in my ear” from the storage unit 144, causes the loudspeaker 133 to output the sound “I have ringing in my ear” of the audio data, and causes the display panel 134 to display the image of the display data of the expression on the character's face when the character has ringing.

Further, the control unit 142c causes the arm 121 and the hand 122 to perform the gesture of the gesture data so as to place the hand over the ear of the character's face displayed on the display panel 134. Here, the control unit 142c can arbitrarily select the motion of yawning or the motion of uttering “I have ringing in my ear” while placing the hand over the ear. When the robot 10 completes performing a series of bridging motions in this manner, the process returns to step S1.

On the other hand, when the communication level is not “2” (that is, the communication failure level is “1”) (NO in S6), the control unit 142c controls the robot 10 by switching the mode to the autonomous control mode in which the robot 10 performs the bridging motion in the case of the communication level 1 (S8).

In detail, the control unit 142c acquires the motion data indicating the motion of uttering “I've got something in my eye” while rubbing the eye with the hand from the storage unit 144, causes the loudspeaker 133 to output the sound “I've got something in my eye” of the audio data, and causes the display panel 134 to display the display data of the expression on the character's face when the character gets something in the eye. At the same time, the control unit 142c causes the arm 121 and the hand 122 to perform the gesture of the gesture data so as to rub the eye of the character's face displayed on the display panel 134.

Alternatively, the control unit 142c acquires the motion data indicating the motion of sneezing from the storage unit 144, causes the loudspeaker 133 to output the sound of sneezing of the audio data, and causes the display panel 134 to display the image of the display data of the expression on the character's face when the character sneezes.

Here, the control unit 142c can arbitrarily select the motion of uttering “I've got something in my eye” while rubbing the eye with the hand or the motion of sneezing. When the robot 10 completes performing a series of bridging motions in this manner, the process returns to step S1.

When the speaker is not the operator, that is, the speaker is the communication partner C (NO in S5), the control unit 142c determines whether the communication level is “2” (S9). When the communication level is “2” (YES in S9), the control unit 142c causes the robot 10 to perform the bridging motion in the case of the communication level 2 as described above, and stores the audio data acquired from the microphone 132 in the storage unit 144 after the communication level becomes “2” or less (S10). When the robot 10 completes performing a series of bridging motions in this manner, the process returns to step S1.

On the other hand, when the communication level is “1” (NO in S9), the control unit 142c causes the robot 10 to perform the bridging motion in the case of the communication level 1 as described above, and stores the audio data acquired from the microphone 132 in the storage unit 144 after the communication level becomes “2” or less (S11). When the robot 10 completes performing a series of bridging motions in this manner, the process returns to step S1.

Here, it is desirable that the control unit 142c transmit the audio data stored in the storage unit 144 to the operation terminal 20 when the communication level has recovered to be “3” or higher. Then, it is desirable that the operation terminal 20 convert, for example, the audio data during the period in which the communication level is “2” or lower into text using a transcript function or the like, and display the text on the display unit 202.

As described above, the communication system 1 and the control method according to the present embodiment cause the robot 10 to perform the bridging motion when a communication failure occurs between the robot 10 and the operation terminal 20. Therefore, even when a communication failure occurs between the robot 10 and the operation terminal 20, the robot 10 can be suppressed from being hung up, and the annoyance felt by the communication partner C who is performing communication via the robot 10 can be reduced.

Moreover, the communication system 1 and the control method according to the present embodiment stores the audio data acquired from the microphone 132 of the robot 10 in the storage unit 144 after a communication failure occurs between the robot 10 and the operation terminal 20. Therefore, after the communication failure is resolved, the audio data transmitted from the control unit 142c of the robot 10 to the operation terminal 20 can be converted into text using, for example, a transcript function, and displayed on the display unit 202 of the operation terminal 20.

With the above, the operator can recognize the speech of the communication partner C during a period in which the communication failure is occurring between the robot 10 and the operation terminal 20. At this time, when the stereo camera 131 of the robot 10 is capturing an image of the communication partner C while the communication failure is occurring, the imaging data may be stored in the storage unit 144, and the imaging data may be transmitted to the operation terminal 20 to display the imaging data after the communication failure is resolved.

The communication system 1 according to the present embodiment includes the second determination unit 142b. However, the second determination unit 142b may be omitted.

Further, in the present embodiment, the audio data stored in the storage unit 144 after a communication failure occurs between the robot 10 and the operation terminal 20 is converted into text and displayed on the display unit 202 of the operation terminal 20. The sound of which playback speed has been adjusted (for example, speeded up) may be output from the loudspeaker 203.

### Second Embodiment

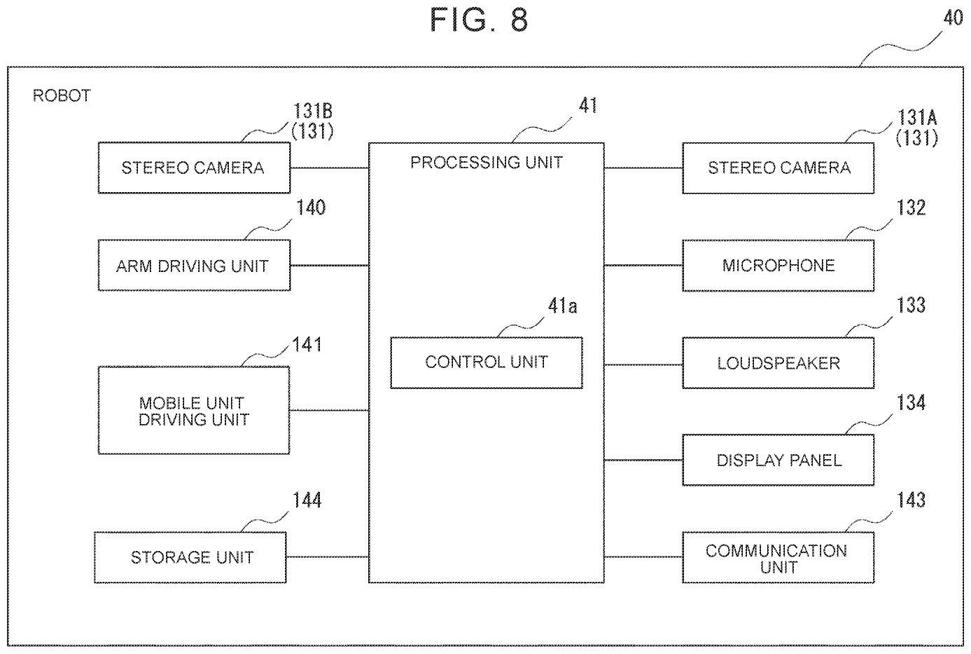

FIG. 8 is a block diagram for explaining the system configuration of the robot according to the present embodiment. A robot 40 according to the present embodiment has substantially the same configuration as the robot 10 according to the first embodiment. Therefore, redundant description will be omitted and the same elements will be described using the same reference numerals.

In the robot 40 according to the present embodiment, when it is clear that communication between the robot 40 and the operation terminal 20 is interrupted for a certain period of time at a preset time for security reasons and the like, the control unit 41a of the processing unit 41 switches the mode from the remote operation mode to the autonomous control mode and causes the robot 40 to perform the bridging motion while the communication is being interrupted.

Therefore, as shown in FIG. 8, the robot 40 according to the present embodiment can omit the first determination unit 142a and the second determination unit 142b, as compared to the robot 10 according to the first embodiment. Here, the bridging motion can be appropriately selected in accordance with the period during which communication between the robot 40 and the operation terminal 20 is interrupted.

As described above, the communication system and the control method as described above cause the robot 40 to perform the bridging motion when a communication failure occurs between the robot 40 and the operation terminal 20. Therefore, even when a communication failure occurs between the robot 40 and the operation terminal 20, the robot 40 can be suppressed from being hung up, and the annoyance felt by the communication partner C who is performing communication via the robot 40 can be reduced.

### Other Embodiments

Although the present disclosure has been described as a hardware configuration in the first and second embodiments, the present disclosure is not limited to this. The present disclosure can also realize the processing of each component by causing a central processing unit (CPU) to execute a computer program.

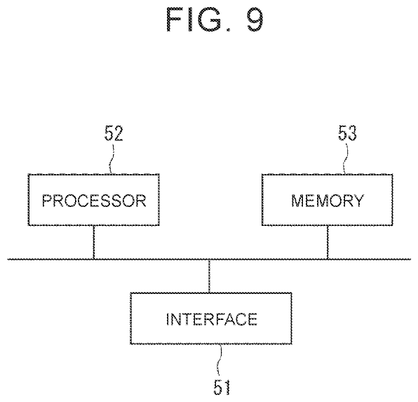

For example, the communication system according to the above embodiment can have the following hardware configuration. FIG. 9 is a diagram showing an example of the hardware configuration included in the communication system.

A device shown in FIG. 9 includes a processor 52 and a memory 53 together with an interface 51. The communication system described in the first and second embodiments is realized in a manner such that the processor 52 reads and executes a program stored in memory 53. That is, the program is a program for making the processor 52 function as a communication system.

Here, the program includes a set of instructions (or software codes) for causing the computer to perform one or more of the functions when loaded into the computer. The program may be stored in a non-transitory computer-readable medium or a tangible storage medium. Examples of the computer-readable medium or the tangible storage medium include, but are not limited to, a random-access memory (RAM), a read-only memory (ROM), a flash memory, a solid-state drive (SSD) or other memory technologies, a compact disc read-only memory (CD-ROM), a digital versatile disc (DVD), a Blu-ray (registered trademark) disc or other optical disc storages, a magnetic cassette, a magnetic tape, a magnetic disc storage, or other magnetic storage devices. The program may be transmitted on a transitory computer-readable medium or a communication medium. The example of the transitory computer-readable medium or the communication medium includes, but is not limited to, an electrical, optical, acoustic, or other form of propagating signal.

The present disclosure is not limited to the above embodiments, and can be appropriately modified without departing from the spirit.

For example, the bridging motions in the above embodiments are examples, and the bridging motion in accordance with the situation in which the robot is actually used and the communication level may be selected from among multiple bridging motions that are set in advance for respective communication levels corresponding to the situations, such as the season in which the robot is used and the installation location, and the robot may be caused to perform the selected bridging motion. However, when it is clear that communication between the robot 40 and the operation terminal 20 is interrupted for a certain period of time at a preset time as in the second embodiment, the bridging motion may be selected depending on the situation in which the robot is used.

For example, in the above embodiments, the communication level is evaluated in five stages. However, the number of evaluation levels can be changed as appropriate. Further, the correspondence relationship between the communication failure state and the communication level can be changed as appropriate.

For example, the robots of the above embodiments are examples, and may be humanoid robots, telepresence robots, or the like. In short, any configuration may be used as long as it is possible to perform the bridging motion when a communication failure occurs between the robot and the operation terminal.

What is claimed is:

1. A communication system in which an operator who remotely operates a robot using an operation terminal communicates with a communication partner who is present around the robot via the robot, the communication system comprising a control unit that causes the robot to perform a bridging motion that is set in advance when a communication failure occurs between the operation terminal and the robot.

2. The communication system according to claim 1, further comprising a first determination unit that determines a communication state between the operation terminal and the robot, wherein when the communication state is a first communication failure state that is set in advance, the control unit switches from a remote operation mode in which the robot is remotely operated via the operation terminal to an autonomous control mode in which the robot performs the bridging motion.

3. The communication system according to claim 2, wherein:
the first determination unit determines a communication level based on a communication speed between the robot and the operation terminal; and
the control unit selects the bridging motion corresponding to the communication level from among a plurality of the bridging motions for which required times that are set in advance are different from each other, and causes the robot to perform the selected bridging motion.

4. The communication system according to claim 1, wherein the control unit selects the bridging motion corresponding to a situation in which the robot is actually used from among a plurality of the bridging motions set in advance corresponding to situations in which the robot is used, and causes the robot to perform the selected bridging motion.

5. The communication system according to claim 1, wherein the bridging motion is a motion that imitates a motion of a person that causes a conversation to be interrupted during the conversation.

6. The communication system according to claim 2, further comprising:
a second determination unit that determines whether a person who speaks just before the communication state becomes a second communication failure state that is set in advance is the operator or the communication partner; and
a storage unit that stores, when the person who speaks just before the communication state becomes the second communication failure state is the communication partner, sound uttered by the communication partner to the operator via the robot from when the communication state becomes the second communication failure state until the second communication failure state is resolved.

7. A control method of a communication system in which an operator who remotely operates a robot using an operation terminal communicates with a communication partner who is present around the robot via the robot, the control method comprising causing the robot to perform a bridging motion that is set in advance when a communication failure occurs between the robot and the operation terminal.

8. A non-transitory storage medium storing a control program of a communication system in which an operator who remotely operates a robot using an operation terminal communicates with a communication partner who is present around the robot via the robot, the control program causing a computer to execute a process of causing the robot to perform a bridging motion that is set in advance when a communication failure occurs between the robot and the operation terminal.
